(19) United States
(12) Patent Application Publication
(10) Pub. No.: US 2009/0062497 A1
(43) Pub. Date: Mar. 5, 2009

(54) Borate Salts, Method for the Production Thereof and Use Thereof

(76) Inventors: Rainer Aul, Rodgau (DE); Ute Emmel, Frankfurt am Main (DE); Ulrich Wietelmann, Friedrichsdorf (DE); Dieter Hauk, Friedberg (DE); Jens Roder, Frankfurt am Main (DE)

Correspondence Address: FULBRIGHT & JAWORSKI, LLP, 666 FIFTH AVE, NEW YORK, NY, 10103-3198, US

(21) Appl. No.: 11/992,618

(22) PCT Filed: Oct. 9, 2006
(86) PCT No.: PCT/EP2006/067205

§ 371 Date: May 12, 2008

(30) Foreign Application Priority Data
Oct. 7, 2005 (DE) 10 2005 048 441.7

(51) Int. Cl. C08G 79/08; C07F 5/04

(52) U.S. Cl. 528/8; 558/298

(57) ABSTRACT

Borate salts, a method for the production thereof and methods of their use.

The present invention provides borate salts, a process for their preparation, and their use.

In particular the present invention provides borate salts as additives, stabilisers, flameproofing agents, conductivity improvements in polymers, as well as electrolytes.

EP-A-0 698 301 discloses lithium complex salts of the type ABL₂ (where A here denotes lithium or a quaternary ammonium ion, B denotes boron and L denotes a bidendate ligand that is bonded via two oxygen atoms to the boron atom) for use in galvanic cells. Such chelate compounds are not commercially available and can be produced only at high cost. These products have therefore not achieved a broad market penetration.

Wholly similar boron compounds are disclosed in EP-A-0 907 217 as constituents in organic electrolytic cells. Compounds of the general Formula LiBXX′ are used as boron-containing conducting salt, where the ligands X and X′ can be identical or different and each ligand contains an electron-attracting, oxygen-containing group that binds to the boron atom. The disclosed compounds (lithium bis(salicylato)borate and a special imide salt) however also exhibit the disadvantages already mentioned above.

The synthesis and use of various complexes of boron as a basis for the preparation of conducting salts and various additives in the battery development sector is disclosed in various patents: DE-C-198 29 030 discloses lithium bis(oxalato)borate (LiBOB), the first boron-centered complex salt described for use as an electrolyte, which employs a dicarboxylic acid (in this case oxalic acid) as chelate component. DE-C-101 08 592 discloses non-symmetrical boron chelate complexes that are extremely suitable as additives in conducting salts.

The technical teaching disclosed in DE-C-198 29 030 and DE-C-101 08 592 is in its full scope part of the present description.

WO-A-2004/072166 discloses the use of various salts of super acids for stabilising halogen-containing polymers, in particular PVC. Inter alia lithium bis(oxalato)borate (LiBOB) is disclosed here as a potentially stabilising component. Where subsequently halogen-containing polymers, for example polyvinyl chloride (PVC), their production, use and processing are discussed, this corresponds to the polymer that is known to the person skilled in the art from the literature (M. W. Allsopp, G. Vianello, Ullmann's Encyclopedia of Industrial Chemistry Poly (Vinyl Chloride), Wiley-VCH Verlag GmbH & Co. KGaA 2000).

As regards the described borate salts such as lithium bis(oxalato)borate (LiBOB) it is known that they hydrolyse extremely quickly on contact with water and thus rapidly lose the desired action in aqueous solution (LiBOB product brochure, Chemetall GmbH Frankfurt/Main 2005).

The hygroscopy and susceptibility to hydrolysis of the conventional boron complexes of dicarboxylic acids such as oxalic acid and malonic acid is described in detail in the relevant literature (E. Besseler, J. Weidlein, Z. Naturforsch. 1982, 37b, 1020-1025). It is mentioned inter alia that bis(oxalato)borates in particular hydrolyse very quickly when exposed to moisture.

This susceptibility of the conventional borate salts to water is particularly disadvantageous when they are used in the battery industry and for the production of battery electrolytes. Secondary products are formed by the hydrolysis, which inter alia influence the conductivity and storage stability and thus adversely affect the desired properties.

Similarly, given the background of the high water content of halogen-containing polymers, for example PVC, and the additives used in their processing, a particularly good hydrolysis stability is desired.

Numerous additives are known for stabilising halogen-containing polymers against thermal and photochemical degradation (R. Wolf, B. Lal Kaul, Ullmann's Encyclopedia of Industrial Chemistry: Plastic Additives, Wiley-VCH Verlag GmbH & Co. KGaA 2000). Thus, for example, PVC can be stabilised by a number of additives. Compounds of the heavy metals lead, barium and cadmium are particularly suitable for this purpose, though nowadays their use is discouraged on ecological grounds or on account of their heavy-metal content (“Kunststoffadditive”, R. Gächter/H. Müller, Carl Hanser Verlag, 3^{rd} Edition, 1989, pp. 303-311; “Kunststoff Handbuch PVC”, Vol. 2/1, W. Becker/D. Braun. Carl Hanser Verlag, 2^{nd} Edition, 1985, pp. 531-538; Kirk-Othmer: “Encyclopedia of Chemical Technology”, 4^{th} Edition, 1994, Vol. 12, Heat Stabilizers, pp. 1071-1091). EP-A-0 677 550 and WO-A-2003/048232 disclose the use of salts of perchloric acid as a further method of stabilising halogen-containing polymers. However, these substances are characterised by their persistence in the environment and behave as biocides that are difficult to degrade. Furthermore it is known that salts of perchloric acid in combination with organic substances can decompose explosively on heating. It is also known to use mixtures of calcium stearate and zinc stearate for stabilising halogen-containing polymers. A disadvantage of this method is that zinc salts formed in the stabilisation can even accelerate the decomposition process during processing (“zinc burning”) (R. Wolf, B. Lal Kaul, Ullmann's Encyclopedia of Industrial Chemistry: Plastic Additives, Wiley-VCH Verlag GmbH & Co. KGaA 2000).

Likewise, the water content or addition of water in the processing of polymers such as polyurethanes prevents the use of known borate salts. Where polyurethanes, their production, processing and use are discussed hereinafter, this corresponds to the polymer that is known to the person skilled in the art from the literature (N. Adam, G. Avar, H. Blankenheim, W. Friederichs, M. Giersig, E. Weigand, Michael Halfmann, F.-W. Wittbecker, D.-R. Larimer, U. Maier, S. Meyer-Ahrens, K.-L. Noble, H.-G. Wussow, Ullmann's Encyclopedia of Industrial Chemistry: Polyurethanes, Wiley-VCH Verlag GmbH & Co. KGaA 2005).

The hygroscopy and susceptibility to hydrolysis of the conventional boron complexes of dicarboxylic acids such as oxalic acid and malonic acid has up to now also prevented their use as flameproofing agents and conductivity improvers in polymers, in particular halogen-containing polymers such as PVC, or in polyurethanes, even though boron complexes are superior in many respects to the conventional additives.

The conventional additives used in polymers as flameproofing agents and conductivity improvers to prevent electrostatic charges have in fact a number of disadvantages. The properties of flameproofing agents are well known to the person skilled in the art (R. Wolf, B. Lal Kaul, Ullmann's Encyclopedia of Industrial Chemistry Plastic Additives, Wiley-VCH Verlag GmbH & Co. KGaA 2000).

Inorganic substances such as aluminium hydroxide, magnesium hydroxide but also antimony trioxide and antimony pentoxide or barium borates for example are commonly used as flameproofing agents. It is known that barium and antimony compounds are poisonous. Likewise, it is known that red phosphorus, which is used as a flameproofing agent, is toxic.

Furthermore, halogenated hydrocarbons, principally chlorine-substituted and bromine-substituted aromatic and aliphatic compounds, are used as flameproofing agents. These compounds are on the one hand extremely costly, and on the other hand they complicate the thermal decomposition and disposal of the plastics, since the combustion has to be carried out at high temperatures. Also, the waste gases have to be specially treated in order to prevent the formation of environmentally harmful substances. It is known that toxic substances such as for example 2,3,7,8-tetrachlorodioxin can be formed in the combustion of halogen-containing hydrocarbons.

A further disadvantage of plastics is that they readily become electrostatically charged and can therefore cause electrostatic discharges. Electrostatic discharges can damage or destroy sensitive electronic components, alter or delete magnetic data carriers, or cause explosions and fire in a combustible environment. Every year damage estimated at 40 billion Euros is caused simply by electrostatic discharges in the electronics industry alone. In order to reduce or if possible avoid electrostatic charging of plastics, the conductivity of plastics is raised so that high electrostatic charges do not occur and any electrostatic charges can be dissipated before they can build up to dangerous levels. This is normally achieved by adding various amounts and types of additives such as powdered carbon black, carbon fibres, metal fibres, metal-coated carbon fibres and metal powders. However, these additives have the disadvantage that they can in some cases have a significant deleterious effect on the mechanical properties of the plastics.

To summarise, the flameproofing agents are toxic and ecologically harmful, while the conductivity improvers often impair the mechanical properties of the polymers. This is not the case, or not to the same extent, with boron complexes.

The object of the present invention is to overcome the disadvantages of the prior art.

In particular the object of the present invention is to provide substances based on boron that are suitable as additives, stabilisers, flameproofing agents, conductivity improvers in polymers and/or as an electrolyte.

The additives should furthermore be based on substances obtained from renewable raw materials, such as for example tartaric acid, other natural acids or amino acids.

According to the invention this object is surprisingly achieved by the features of the main claim. Preferred embodiments are disclosed in the sub-claims.

In particular the object is achieved by symmetrical or non-symmetrical borate salts of the Formula I illustrated hereinafter.

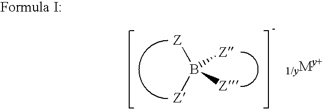

wherein:
Z, Z′, Z″, Z′″=independently of one another a heteroatom, for example oxygen O or sulphur S, or a nitrogen group NR³
   and:

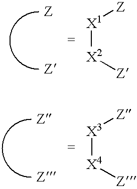

(in linearized form: Z-Z′=ZX¹-X²Z′ and Z″-Z′″=Z″X³-X⁴Z′″)
and:
X¹, X², X³, X⁴=independently of one another —C(═O)— or —C(R¹R²)— or —C(R¹R²)—C(═O)— or —C(R¹R²)—C(R¹R²)—, wherein: if X¹=X²=X³=—C(═O)— and at the same time Z, Z′, Z″, Z′″=O, then X⁴≠—C(═O)—,
   and/or:
X¹, X², X³, X⁴=independently of one another —C(═O)— or —C(R¹R²)— or —C(R¹R²)—C(═O)— or —C(R¹R²)—C(R¹R²)— as substituent on a 1,2-aryl compound, with up to 2 further substituents G¹, G² in positions 3 to 6 or X² and/or X⁴ correspond to the carbon atoms in the 1 position and with X¹ and X³ independently of one another —C(═O)— or —C(R¹R²)— or —C(R¹R²)—C(═O)— —C(R¹R²)—C(R¹R²)— in the 2 position of a 1,2-aryl compound, with up to 2 substituents G¹, G² is positions 3 to 6 or X¹, X² and/or X³, X⁴ correspond to the carbon atoms in the 1 or 2 position of a 1,2-aryl compound, with up to 2 substituents G¹, G² in positions 3 to 6,

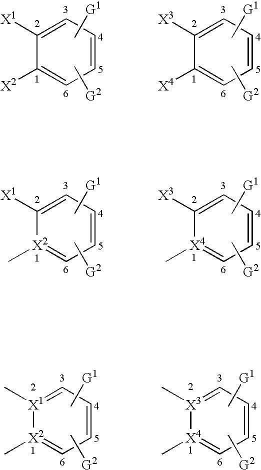

wherein G¹, G²=independently of one another H or SR³ or OR³ or NR³R⁴, or a functionalized or a non-functionalized branched or unbranched alkyl, alkenyl, alkinyl, cycloalkyl group with 1 to 20 C atoms or is an aryl group with 1 to 12 C atoms or silyl or halide or a polymer radical,
and:
R¹, R²=independently of one another H, Sr³ or OR³ or NR³R⁴, or a functionalized or a non-functionalized branched or unbranched alkyl or cycloalkyl group with 1 to 20 C atoms or an aryl group with 1 to 12 C atoms with up to 2 substituents G¹, G², or silyl or a polymer radical and/or one of the alkyl radicals R¹ or R² can be bonded to a further chelatoborate radical,
   and:
R³, R⁴, R⁵, R⁶=independently of one another H or a functionalized or non-functionalized branched or unbranched alkyl, alkenyl, alkinyl, cycloalkyl group with 1 to 20 C atoms or an aryl group with 1 to 12 C atoms or silyl, or a polymer radical,
   and:
y=denotes the number of positive charges on the cation M^{y+}, where y=1, 2, 3, 4, 5 or 6,
   and:
M^{y+}=a main-group metal, alkali metal, alkaline-earth metal, rare-earth metal or transition metal cation or [(R³R⁴R⁵R⁶)N]⁺ or H⁺.

According to the invention M^{y+} is preferably a lithium, sodium, potassium, caesium, calcium, zinc, neodymium, lanthanum or aluminium cation, or an ammonium cation trisubstituted with hydrocarbon, an ammonium cation tetrasubstituted with hydrocarbon or a dialkylanilinium cation.

According to the invention preferred ammonium cations are trimethylammonium, triethylammonium, tripropylammonium, triisopropylammonium, tri(n-butyl)ammonium, N,N-dimethylphenylammonium, N,N-dimethylbenzylammonium, N,N-diethylphenylammonium, N,N-diethylbenzylammonium, N,N-dimethyl(2,4,6-trimethylphenyl)ammonium, N,N-dimethyl(2,4,6-triethylphenyl)ammonium, N,N-dimethyl(2,4,6-trimethylbenzyl)ammonium, N,N-dimethyl(2,4,6-triethylbenzyl)ammonium, N,N-di(tetradecyl)phenylammonium, N,N-di(tetradecyl)(2,4,6-trimethyl-phenyl)ammonium, N,N-di(octadecyl)phenylammonium, N,N-di(octadecyl)(2,4,6-trimethylphenyl)ammonium, methyldicyclohexylammonium, N,N-dimethylphenylammonium, triphenylammonium, tetramethylammonium, tetraethylammonium, tetrapropylammonium, tetraisopropylammonium, tetra(n-butyl)ammonium.

Particularly preferred according to the invention are tetramethylammonium, tetraethylammonium, tetrapropylammonium, tetraisopropylammonium, tetra(n-butyl)ammonium, N,N-dimethylphenylammonium, methylbis(octadecyl)ammonium, dimethyloctadecylammonium, methylbis(tetradecyl)ammonium, N,N-bis(octadecyl)phenylammonium and N,N-bis(octadecyl)(3,5-dimethylphenyl)ammonium. Also preferred are mixtures of variously substituted ammonium cations. Examples of these are the ammonium cations of commercially available amines which contain mixtures of two C₁₄, C₁₆ or C₁₈ alkyl groups and a methyl group. Such amines are obtainable from Chemtura under the trade name Kemamine™ T9701 and from Akzo-Nobel under the trade name Armeen™ M2HT.

Examples of R¹ and R² are: H, F, Cl, Br, I, OH, methyl, chloromethyl, bromomethyl, hydroxymethyl, methoxymethyl, ethoxymethyl, mercaptomethyl, (methylmercapto)methyl, (ethylmercapto)methyl, aminomethyl, carboxymethyl, carboxyhydroxymethyl, (methylcarboxy)methyl, hydroxy(methylcarboxy)methyl, (ethylcarboxy)methyl, hydroxy(ethylcarboxy)methyl, ethyl, 1-hydroxyethyl, 2-hydroxyethyl, 1-chloroethyl, 2-chloroethyl, 1-bromoethyl, 2-bromoethyl, 2-methoxyethyl, 2-ethoxyethyl, 2-mercaptoethyl, 2-(methylmercapto)ethyl, 2-(ethylmercapto)ethyl, 2-aminoethyl, carboxyethyl, carboxy-2-hydroxyethyl, carboxy-1-hydroxyethyl, (methylcarboxy)ethyl, (ethylcarboxy)ethyl, (methylcarboxy)-2-hydroxyethyl, (methylcarboxy)-1-hydroxyethyl, (ethylcarboxy)-2-hydroxyethyl, (ethylcarboxy)-1-hydroxyethyl, ethenyl, ethinyl, n-propyl, iso-propyl, propen-3-yl, propin-3-yl, 1-hydroxypropyl, 2-hydroxypropyl, 1-mercaptopropyl, 2-mercaptopropyl, 2-aminopropyl, 3-hydroxypropyl, 3-mercaptopropyl, 3-aminopropyl, 1-chlorobutyl, 2-chlorobutyl, 3-chlorobutyl, 4-chlorobutyl, 1-bromobutyl, 2-bromobutyl, 3-bromobutyl, 4-bromobutyl, n-butyl, 1-chloropropyl, 2-chloropropyl, 3-chloropropyl, 1-bromopropyl, 2-bromopropyl, 3-bromopropyl, 1-hydroxybutyl, 2-hydroxybutyl, 3-hydroxybutyl, 4-hydroxybutyl, 1-mercaptobutyl, 2-mercaptobutyl, 3-mercaptobutyl, 4-mercaptobutyl, 1-aminobutyl, 2-aminobutyl, 3-aminobutyl, 4-aminobutyl, carboxybutyl, (methylcarboxy)butyl), (ethylcarboxy)butyl, 1-buten-4-yl, 1-butin-4-yl, 2-buten-4-yl, 2-butin-4-yl, 2-butyl, iso-butyl, tert-butyl, 2-hydroxybutyl, 2-mercaptobutyl, 2-aminobutyl, 3-hydroxybutyl, 3-mercaptobutyl, 3-aminobutyl, 4-hydroxybutyl, 4-mercaptobutyl, 4-aminobutyl, n-pentyl, iso-pentyl, neo-pentyl, tert-pentyl, hexyl, n-heptyl, iso-heptyl, n-octyl, iso-octyl, 2-ethyl-1-hexyl, 2,2,4-trimethylpentyl, nonyl, decyl, dodecyl, n-dodecyl, cyclopentyl, cyclohexyl, cycloheptyl, methylcyclohexyl, vinyl, 1-propenyl, 2-propenyl, naphthyl, anthranyl, phenanthryl, o-tolyl, p-tolyl, m-tolyl, xylyl, ethylphenyl, mesityl, phenyl, pentafluorophenyl, benzyl, mesistyl, neophyl, thexyl, trimethylsilyl, triisopropylsilyl, tri(tertbutyl)silyl), dimethylthexylsilyl, trimethylsilylethinyl, dimethyltertbutylsilylethinyl, dimethylthexylsilylethinyl, triisopropylsilylethinyl, tritertbutylsilylethinyl, wherein amino denotes NR³R⁴.

Examples of R³, R⁴, R⁵ and R⁶ are: H, methyl, hydroxymethyl, mercaptomethyl, aminomethyl, (formamid)yl, (dimethylformamid)yl, (formamidin)yl, (N,N-dimethylformamidin)yl, ethyl, 2-hydroxyethyl, 2-mercaptoethyl, 2-aminoethyl, ethenyl, ethinyl, n-propyl, iso-propyl, cyclopropyl, propen-3-yl, propin-3-yl, 2-hydroxypropyl, 2-mercaptopropyl, 2-aminopropyl, 3-hydroxypropyl, 3-mercaptopropyl, 3-aminopropyl, n-butyl, 1-buten-4-yl, 1-butin-4-yl, 2-buten-4-yl, 2-butin-4-yl, 2-butyl, iso-butyl, tert-butyl, 2-hydroxybutyl, 2-mercaptobutyl, 2-aminobutyl, 3-hydroxybutyl, 3-mercaptobutyl, 3-aminobutyl, 4-hydroxybutyl, 4-mercaptobutyl, 4-aminobutyl, n-pentyl, iso-pentyl, neo-pentyl, tert-pentyl, hexyl, n-heptyl, iso-heptyl, n-octyl, iso-octyl, 2-ethyl-1-hexyl, 2,2,4-trimethylpentyl, nonyl, decyl, dodecyl, n-dodecyl, cyclopentyl, cyclohexyl, cycloheptyl, methylcyclohexyl, vinyl, 1-propenyl, 2-propenyl, naphthyl, anthranyl, phenanthryl, o-tolyl, p-tolyl, m-tolyl, xylyl, ethylphenyl, mesityl, phenyl, benzyl, derivatives of substituted and unsubstituted aromatic compounds such as benzene, fluorene, indene, indane, trimethylsilyl, triisopropylsilyl, tri(tertbutyl)silyl), dimethylthexylsilyl, trimethylsilylethinyl, dimethyltertbutylsilylethinyl, dimethylthexylsilylethinyl, triisopropylsilyl ethinyl, tritertbutylsilylethinyl, wherein amino denotes NR³R⁴.

Examples of G¹ and G² are: H, OH, SH, NH₂, N(methyl)₂, O-methyl, S-methyl, methyl, hydroxymethyl, mercaptomethyl, aminomethyl, ethyl, 2-hydroxyethyl, 2-mercaptoethyl, 2-aminoethyl, ethenyl, ethinyl, n-propyl, iso-propyl, propen-3-yl, propin-3-yl, 2-hydroxypropyl, 2-mercaptopropyl, 2-aminopropyl, 3-hydroxypropyl, 3-mercaptopropyl, 3-aminopropyl, n-butyl, 1-buten-4-yl, 1-butin-4-yl, 2-buten-4-yl, 2-butin-4-yl; 2-butyl, iso-butyl, tert-butyl, 2-hydroxybutyl, 2-mercaptobutyl, 2-aminobutyl, 3-hydroxybutyl, 3-mercaptobutyl, 3-aminobutyl, 4-hydroxybutyl, 4-mercaptobutyl, 4-aminobutyl, n-pentyl, iso-pentyl, neo-pentyl, tert-pentyl, hexyl, n-heptyl, iso-heptyl, n-octyl, iso-octyl, 2-ethyl-1-hexyl, 2,2,4-trimethylpentyl, nonyl, decyl, dodecyl, n-dodecyl, cyclopentyl, cyclohexyl, cycloheptyl, methylcyclohexyl, vinyl, 1-propenyl, 2-propenyl, naphthyl, anthranyl, phenanthryl, o-tolyl, p-tolyl, m-tolyl, xylyl, ethylphenyl, mesityl, phenyl, 4-hydroxyphenyl, styryl, pentafluorophenyl, benzyl, trimethylsilyl, triisopropylsilyl, tri(tertbutyl)silyl), dimethylthexylsilyl, trimethylsilylethinyl, dimethyltertbutylsilylethinyl, dimethylthexylsilylethinyl, triisopropylsilylethinyl, tritertbutylsilyiethinyl, fluorine, chlorine, bromine, iodine, where amino denotes NR³R⁴.

Examples of Z-Z′ and Z″-Z′″ are:

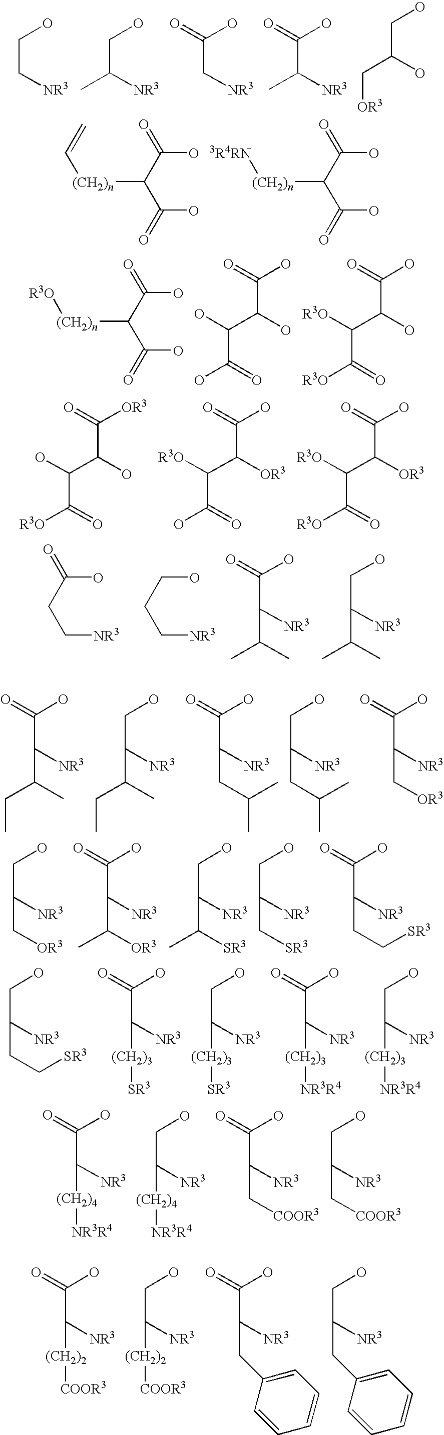

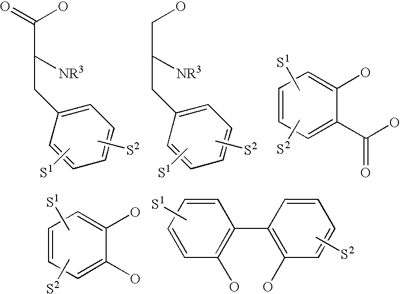

According to the invention the following compounds are preferred: hydrogen-(malonato,oxalato)borate (HMOB), hydrogen-bis(malonato)borate (HBMB), hydrogen-(glycolato,oxalato)borate (HGOB), hydrogen-bis(glycolato)borate (HBGB), hydrogen-(lactato,oxalato)borate (HLOB), hydrogen-bis(lactato)borate (HBLB), hydrogen-(oxalato,salicylato)borate (HOSB), hydrogen-bis(salicylato)borate (HBSB), hydrogen(oxalato,tartrato)borate (HOTB), hydrogen(polytartrato)borate (HPTB), hydrogen(oxalato,catecholato)borate (HOCB), hydrogenbis(catecholato)borate (HBCB) as well as the ammonium, alkali metal, alkaline-earth metal, rare-earth metal and main group metal and transition group metal salts of the aforementioned acids. Particularly preferred are the lithium, sodium, potassium, caesium, calcium, zinc, neodymium, lanthanum, aluminium, tetraalkylammonium salts, tetramethylammonium, tetraethylammonium, tetrapropylammonium, tetraisopropylammonium, tetra(n-butyl)ammonium and dialkylanilinium salts, N,N-dimethylphenylammonium, methylbis(octadecyl)ammonium, dimethyloctadecylammonium, methylbis-(tetradecyl)ammonium, N,N-bis(octadecyl)phenylammonium and N,N-bis(octadecyl)(3,5-dimethylphenyl)ammonium salts of the aforementioned acids. Also preferred as cations are mixtures of variously substituted ammonium cations. Examples of these are the ammonium cations of commercially available amines which contain mixtures of two C₁₄, C₁₆ or C₁₈ alkyl groups and a methyl group. Such amines are obtainable for example from Chemtura under the trade name Kemamine™ T9701 and from Akzo-Nobel under the trade name Armeen™ M2HT.

Particularly preferred according to the invention are borate salts that are derivatives of boric acid as well as of tartaric acid.

The borate salts according to the invention can be prepared by reacting boric acid and/or one or more boric acid esters with 0.5 to 3 equivalents, preferably 1 to 2.5 equivalents, of the protonated compounds HZ-Z′H or HZ″-Z′″H and a carbonate [(M^{y+})₂₍CO₃)_{y}] of the selected cation M^{y+} or a hydroxide [(M^{y+})(OH)_{y}] of the selected cation M^{y+} or an oxide [(M^{y+})₂(O)_{y}] of the selected cation M^{y+} or an alcoholate [(M^{y+})(OR³)_{y}] of the selected cation M^{y+} or an alkyl [(M^{y+})(R³)_{y}] of the selected cation M^{y+} and/or a compound NR³R⁴R⁵ and/or a compound [(NR³R⁴R⁵R⁶)⁺Q⁻] or a mixture of at least two of the carbonates and/or hydroxides and/or oxides and/or alcoholates and/or alkyls of the selected cation M^{y+} and/or a compound NR³R⁴R⁵ or a compound [(NR³R⁴R⁵R⁶)⁺Q⁻] in a suitable solvent, wherein Q⁻ is a suitable anion, for example a halide, sulfate, hydrogen sulfate, in particular chloride. The ratio of the equivalent of boric acid or boric acid ester to the equivalent of the selected cation M^{y+} is (y±1) to 1, preferably (y±0,1) to 1. Water can be added to the reaction mixture. The water of reaction or alcohol of reaction that is formed is removed, following which the solvent is subsequently completely removed. Suitable solvents are for example benzene, toluene, ethylbenzene, m-xylene, p-xylene, o-xylene, cumene, other derivatised benzenes, hexane, heptane, cyclohexane, methylcyclohexane, hydrocarbon mixtures such as halpasol, shellsol, for example shellsol D80 or D100, chloroform, carbon tetrachloride, but also ethyl acetate, acetone, ethylene carbonate, acetonitrile, wherein in the case of the last-mentioned compounds the water or alcohol can be removed by distillation.

The borate salts according to the invention are characterised by a high stability against hydrolysis and a low hygroscopy, which means that they are very stable with respect to water and hydrolyse only very slowly. This is particularly so compared to the salts of bis(oxalato)borate (BOB), and again particularly compared to lithium-bis(oxalato)borate (LiBOB).

The borate salts according to the invention are only slightly toxic and burn to form ecologically harmless substances. In a preferred embodiment according to the invention they do not contain heavy metals, and in particular do not contain lead or cadmium.

The borate salts according to the invention are suitable as additives in polymers and/or mixtures of polymers, in particular as stabilisers, especially against thermal and/or photochemical decomposition, as flameproofing agents, i.e. as flame-inhibiting additives, and/or as conductivity improvers, in particular to prevent or reduce the build-up of electrostatic charges. They decompose to form flame-inhibiting compounds that do not have the disadvantages of conventional flameproofing agents. Also, they raise the conductivity of polymers without impairing their mechanical properties.

Examples of polymers include polylactate, polyesters such as polyethylene terephthalate (PET), polybutylene terephthalate (PBT), polyethyelene naphthenate (PEN), polyamides, for example nylon, Nomex, Keflar, halogen-containing polymers, for example PVC, polytetrafluoroethene (PTFE, Teflon®), polyolefins, for example polyethylene (PE), polypropylene (PP), as well as polystyrenes, polyacrylates and polyurethanes.

Moreover the borate salts according to the invention are suitable as additives in thermoplastic elastomers such as butadiene rubber (BR), polyisoprene, butadiene-styrene polymers (SBR, SBS rubbers) or natural rubbers, natural latex and synthetic latex, and mixtures of at least two of these elastomers.

Particularly when used as a constituent of halogen-containing polymers, the borate salts according to the invention exhibit an excellent initial colour as well as colour stability.

The polymers can be produced from unit monomers or can consist of mixtures of different monomers. They can also contain recycled material and/or be produced from recycled polymers.

By a suitable choice of the substituents X¹, X², X³, X⁴, R¹, R², R³, R⁴, R⁵, R⁶, G¹ and G² the compatibility of the borate salts according to the invention can be adapted to the polymer. In this connection a very low migration behaviour and plate out-free behaviour can be adjusted corresponding to the relevant requirements, whether on grounds of industrial hygiene, allowability restrictions or processing safety.

A suitable choice of the substituents X¹, X², X³, X⁴, R¹, R², R³, R⁴, R⁵, R⁶, G¹ and G² also offers the possibility of incorporating the borate salts according to the invention directly into the polymers.

The borate salts according to the invention can be added as co-monomers directly during the production or polymerisation of the polymers, and can thus by a suitable choice of the substituents X¹, X², X³, X⁴, R¹, R², R³, R⁴, R⁵, R⁶, G¹ and G² be directly incorporated into the polymer matrix. However, the borate salts according to the invention can also be added at any suitable time before and/or during and/or after the production and/or during the compounding of the polymers themselves and incorporated into the polymer matrix.

The borate salts according to the invention can also be added subsequently to the polymers.

The incorporation of the borate salts according to the invention into the polymer matrix can take place via physical forces.

The incorporation of the hydrolysis-resistant borate salts according to the invention into the polymer matrix can be effected by means of chemical bonding of suitable substituents X¹, X², X³, X⁴, R¹, R², R³, R⁴, R⁵, R⁶, G¹ and G² with constituents of monomers for the polymer production and/or oligomers and/or a polymer.

The borate salts according to the invention are added to the polymers, preferably halogen-containing polymers, particularly preferably PVC or PTFE, or polyurethanes, in amounts of 0.0001 to 10 wt. %. An addition of 0.01 to 3 wt. % is preferred.

In order to simplify the incorporation into the monomer and/or oligomer and/or polymer, a suitable solvent or suspension agent can be added to the borate salts according to the invention.

The borate salts according to the invention can however also be incorporated into the polymers without prior addition of a suitable solvent or suspension agent or other liquid components. For this purpose the borate salts according to the invention are preferably used as powder in finely divided form. In this case it is particularly preferred to prepare the borate salts according to the invention as a finely divided powder by means of a suitable synthesis process, or to reduce the particle size by a suitable grinding process after the synthesis.

So that the powder can be processed more conveniently and efficiently, it can be pelletised or granulated or treated in a dust-free manner in conjunction with a suitable auxiliary agent, for example with waxes, paraffins and/or oils.

In addition the borate salts according to the invention can be mixed with further additives that are required for the processing of the polymers.

The borate salts according to the invention can be employed with the mixed metal stabilisers conventionally used in the processing of halogen-containing polymers, such as barium, cadmium, barium/zinc and/or calcium/zinc compounds, preferably with carboxylates such as stearates, laurates, oleates, alkylbenzoates, naphthenates or phenolates.

Further additives and/or organic and/or inorganic dyes and/or organic and/or inorganic pigments can optionally be added in conventional amounts of 0.0001 to 5 wt. % to the polymer mixture in order to impart a desired colour.

The polymers containing the borate salts according to the invention as additives can be used in all possible applications of the respective polymers, for example as bottles, films, sheets, fibres, moulded articles, shoe soles, foamed materials, materials having a glass-like appearance, automobile tyres, rubbers, lacquers, powder lacquers, piping, drinking water pipes, waste water pipes, profiled sections, window profiles, foodstuff packaging, computer keyboards, computer housings, screen housings, electronics components, blister packaging and industrial plastics.

In a preferred embodiment the borate salts according to the invention can be used as stabiliser in halogen-containing polymers, that can be used for example for the production of bottles, films, sheets, fibres, moulded articles, shoe soles, foamed materials, materials having a glass-like appearance, automobile tyres, rubbers, lacquers, powder lacquers, piping, drinking water pipes, waste water pipes, profiled sections, window profiles, foodstuff packaging, computer keyboards, computer housings, screen housings, electronics components, blister packaging and industrial plastics.

Mixtures of at least two borate salts according to the invention of the Formula I are also suitable for the aforementioned applications.

The present invention moreover provides the aforementioned polymers that contain as additive a borate salt or a plurality of borate salts according to Formula I.

The following examples are intended to illustrate the invention in more detail without however restricting its scope.

### EXAMPLE 1

### General Synthesis of Hydrolysis-Resistant Borate Salts

1 equivalent of boric acid or 1 equivalent of a boric acid ester, for example trimethyl borate or triisopropyl borate, is reacted in a suitable solvent with 0.5 to 3 equivalents, preferably 1 to 2.5 equivalents of protonated compounds HZ-Z′H or HZ′-Z′″H and 1/y equivalent of a carbonate [(M^{y+})₂(CO₃)_{y}] of the selected cation M^{y+} or 1/y equivalent of a hydroxide [(M^{y+})(OH)_{y}] of the selected cation M^{y+} or 1/y equivalent of an oxide [(M^{y+})₂(O)_{y}] of the selected cation M^{y+} or 1/y equivalent of an alcoholate [(M^{y+})(OR³)_{y}] of the selected cation M^{y+}, wherein OR³ is preferably an alcoholate such as methoxide, ethoxide, propoxide, isopropoxide, 2-ethylhexoxide, tert-butoxide, tert-amoxide or amoxide, or 1/y equivalent of an alkyl [(M^{y+})(R³)_{y}] of the selected cation M^{y+} or 1 equivalent of a compound NR³R⁴R⁵ or 1 equivalent of a compound [(NR³R⁴R⁵R⁶)⁺Q⁻] with Q⁻ or 1/y equivalent of a mixture of at least two of the carbonates and/or hydroxides and/or oxides of the selected cation M^{y+} and/or a compound NR³R⁴R⁵ and/or a compound NR³R⁴R⁵R⁶⁺, wherein Q⁻ is a suitable anion, for example a halide, sulfate, hydrogen sulfate, in particular chloride. Water can be added to the reaction mixture. The water of reaction or the alcohol of reaction that is formed is first of all removed by azeotropic distillation, following which the solvent is completely removed in vacuo. Suitable solvents are for example benzene, toluene, ethylbenzene, m-xylene, p-xylene, o-xylene, cumene, other derivatised benzenes, hexane, heptane, cyclohexane, methylcyclohexane, hydrocarbon mixtures such as shellsol, shellsol D80, shellsol D100, halpasol, chloroform, carbon tetrachloride, but also ethyl acetate, acetone, ethylene carbonate, acetonitrile, wherein in the case of the last-mentioned solvents the water or the alcohol is removed by distillation.

### EXAMPLE 2

### Preparation of calcium bis(dimalonatoborate) Ca(BMB)₂

Boric acid (43 g, 0.7 mole), calcium oxide (21 g, 0.35 mole) and malonic acid (155 g, 1.4 mole) are suspended in 375 g of toluene. After adding 10 ml of water the reaction mixture is heated to boiling. The water is removed by azeotropic distillation.

After completion of the reaction the toluene is removed under a high vacuum. The remaining solids are comminuted by means of a ball mill.

### EXAMPLE 3

### Determination of the Hydrolysis Susceptibility of Borate Salts

Ca. 5% solutions of LiBMB, LiMOB and LiBOB (comparison system) are prepared in water and stirred for 2 hours at room temperature. The degree of hydrolysis of the compounds is given in Table 1:

TABLE 1

| | LiBMB | LiMOB | LiBOB (Comp.) |
|---|---|---|---|
| Degree of hydrolysis [%] | 5 | 15 | >50 |

### EXAMPLE 4

### Determination of the Hydrolysis Susceptibility of Borate Salts in D₂O

The hydrolysis susceptibility of borate salts in D₂O is determined by integrating the signals of the ¹¹B NMR measurements. All investigated borates, except for LiBOB and the other salts of the BOB anion, show a moderate to good stability in water. The degree of hydrolysis of the various borate salts after 4 hours in D₂O is shown in Table 2.

TABLE 2

| | | | | | LiBOB | Al(BOB)₃ |
|---|---|---|---|---|---|---|
| | LiBMB | Zn(BMB)₂ | Ca(BMB)₂ | Ca(BSB)₂ | (Comp.) | (Comp.) |
| Degree of hydrolysis [%] | 3 | 47 | 6 | 30 | >80 | >50 |

### EXAMPLE 5

### Determination of the Hygroscopy of Borate Salts

Various metal borates were exposed for 7 weeks to a relative atmospheric humidity of 30%. The borates according to the invention have a lower or no hygroscopy compared to LiBOB and other salts of the BOB anion. The increase in weight [%] of the borates as a measure of the hygroscopy is shown in Table 3.

TABLE 3

| | LiBOB | Zn(BOB)₂ | Al(BOB)₃ | | | | | | |
|---|---|---|---|---|---|---|---|---|---|
| | (Comp.) | (Comp.) | (Comp.) | LiBMB | Ca(BMB)₂ | Zn(BMB)₂ | Al(BMB)₃ | KPTB | Ca(BSB)₂ |
| Increase | 30 | 30 | 33 | 5 | 0.5 | 12 | 10 | 6 | 2 |
| in weight | | | | | | | | | |
| [%] | | | | | | | | | |

1-25. (canceled)

26. A symmetrical or non-symmetrical borate salt of Formula I: 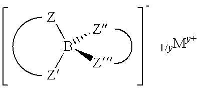
wherein
Z, Z′, Z″, Z′″ are independently a heteroatom or a nitrogen group NR³
and: 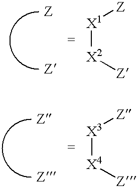
and
X¹, X², X³, X⁴ are independently —C(═O)— or —C(R¹R²)— or —C(R¹R²)—C(═O)— or —C(R¹R²)—C(R¹R²)—, wherein: if X¹=X²=X³=—C(═O)— and at the same time Z, Z′, Z″, Z′″=O, then X⁴≠—C(═O)—,
and/or:
X¹, X², X³, X⁴ are independently of one another —C(═O)— or —C(R¹R²)— or —C(R¹R²)—C(═O)— or —C(R¹R²)—C(R¹R²)— as substituent on a 1,2-aryl compound, with up to 2 further substituents G¹, G² in positions 3 to 6 or X² and/or X⁴ correspond to the carbon atoms in the 1 position and with X¹ and X³ independently of one another being —C(═O)— or —C(R¹R²)— or —C(R¹R²)—C(═O)— or —C(R¹R²)—C(R¹R²)— in the 2 position of a 1,2-aryl compound, with up to 2 substituents G¹, G² in positions 3 to 6 or X¹, X² and/or X³, X⁴ correspond to the carbon atoms in the 1 or 2 position of a 1,2-aryl compound, with up to 2 substituents G¹, G² in positions 3 to 6, 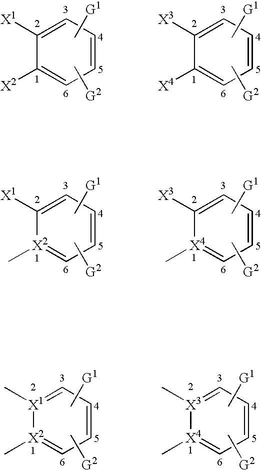
wherein G¹, G² are independently of one another H or SR³ or OR³ or NR³R⁴, or a functionalized or a non-functionalized branched or unbranched alkyl, alkenyl, alkinyl, cycloalkyl group with 1 to 20 C atoms or an aryl group with 1 to 12 C atoms or silyl or halide or a polymer radical,
and:
R¹, R² are independently H, SR³ or OR³ or NR³R⁴, or a functionalized or a non-functionalized branched or unbranched alkyl or cycloalkyl group with 1 to 20 C atoms or an aryl group with 1 to 12 C atoms with up to 2 substituents G¹, G², or silyl or a polymer radical and/or one of the alkyl radicals R¹ or R² can be bonded to a further chelatoborate radical;
R³, R⁴, R⁵, R⁶ are independently H; a functionalized or non-functionalized branched or unbranched C1-C20 alkyl, alkenyl, alkinyl, cycloalkyl group; a C1-C12 aryl group, silyl; or a polymer radical;
y is the number of positive charges on the cation M^{y+} and wherein y is 1, 2, 3, 4, 5 or 6;
M^{y+} is a main-group metal, alkali metal, alkaline-earth metal, rare-earth metal or transition metal cation or [(R³R⁴R⁵R⁶)N]⁺ or H⁺, preferably a lithium, sodium, potassium, caesium, calcium, zinc, neodinium, lanthanum or aluminum cation, a tetraalkylammonium cation, tetramethylammonium, tetraethylammonium, tetrapropylammonium, tetraisopropylammonium, tetra(n-butyl)ammonium, dialkylanilinium, N,N-dimethylphenylammonium, methyl-bis(octadecyl)ammonium, dimethyloctadecylammonium, methylbix(tetradecyl)ammonium, N,N-bis (octadecyl)phenylammonium or N,N-bis(octadecyl)(3,5-dimethylphenyl)ammonium Cation.

27. A borate salt according to claim 26, wherein R¹ and R² independently of one another are selected from: H, F, Cl, Br, I, OH, methyl, chloromethyl, bromoethyl, hydroxymethyl, methoxymethyl, ethoxymethyl, mercaptomethyl, (methylmercapto)methyl, (ethylmercapto)methyl, aminomethyl, carboxymethyl, carboxyhydroxymethyl, (methylcarboxy)methyl, hydroxy-(methylcarboxy)methyl, (ethylcarboxy)methyl, hydroxy(ethylcarboxy)methyl, ethyl, 1-hydroxyethyl, 2-hydroxyethyl, 1-chloroethyl, 2-chloroethyl, 1-bromoethyl, 2-bromoethyl, 2-methoxyethyl, 2-ethoxyethyl, 2-mercaptoethyl, 2-(methylmercapto)ethyl, 2-(ethylmercapto)ethyl, 2-aminoethyl, carboxyethyl, carboxy-2-hydroxyethyl, carboxy-1-hydroxyethyl, (methylcarboxy)ethyl, (ethylcarboxy)ethyl, (methylcarboxy)-2-hydroxyethyl, (methylcarboxy)-1-hydroxyethyl, (ethylcarboxy)-2-hydroxyethyl, (ethylcarboxy)-1-hydroxyethyl, ethenyl, ethinyl, n-propyl, iso-propyl, propen-3-yl, propin-3-yl, 1-hydroxypropyl, 2-hydroxypropyl, 1-mercaptopropyl, 2-mercaptopropyl, 2-aminopropyl, 3-hydroxypropyl, 3-mercaptopropyl, 3-aminopropyl, 1-chlorobutyl, 2-chlorobutyl, 3-chlorobutyl, 4-chlorobutyl, 1-bromobutyl, 2-bromobutyl, 3-bromobutyl, 4-bromobutyl, n-butyl, 1-chloropropyl, 2-chloropropyl, 3-chloropropyl, 1-bromopropyl, 2-bromopropyl, 3-bromopropyl, 1-hydroxybutyl, 2-hydroxybutyl, 3-hydroxybutyl, 4-hydroxybutyl, 1-mercaptobutyl, 2-mercaptobutyl, 3-mercaptobutyl, 4-mercaptobutyl, 1-aminobutyl, 2-aminobutyl, 3-aminobutyl, 4-aminobutyl, carboxybutyl, (methylcarboxy)butyl), (ethylcarboxy)butyl, 1-buten-4-yl, 1-butin-4-yl, 2-buten-4-yl, 2-butin-4-yl, 2-butyl, iso-butyl, tert-butyl, 2-hydroxybutyl, 2-mercaptobutyl, 2-aminobutyl, 3-hydroxybutyl, 3-mercaptobutyl, 3-aminobutyl, 4-hydroxybutyl, 4-mercaptobutyl, 4-aminobutyl, n-pentyl, iso-pentyl, neo-pentyl, tert-pentyl, hexyl, n-heptyl, iso-heptyl, n-octyl, iso-octyl, 2-ethyl-1-hexyl, 2,2,4-trimethylpentyl, nonyl, decyl, dodecyl, n-dodecyl, cyclopentyl, cyclohexyl, cycloheptyl, methylcyclohexyl, vinyl, 1-propenyl, 2-propenyl, naphthyl, anthranyl, phenanthryl, o-tolyl, p-tolyl, m-tolyl, xylyl, ethylphenyl, mesityl, phenyl, pentafluorophenyl, benzyl, mesityl, neophyl, thexyl, trimethylsilyl, triisopropylsilyl, tri(tertbutyl)silyl), dimethylthexylsilyl, trimethylsilylethinyl, dimethyltertbutylsilylethinyl, dimethylthexylsilylethinyl, triisopropylsilylethinyl, tritertbutylsilylethinyl, where amino denotes NR³R⁴.

28. A borate salt according to claim 26, wherein R³, R⁴, R⁵ and R⁶ independently of one another are selected from H, methyl, hydroxymethyl, mercaptomethyl, aminomethyl, (formamid)yl, (dimethylformamid)yl, (formamidin)yl, (N,N-dimethylformamidin)yl, ethyl, 2-hydroxyethyl, 2-mercaptoethyl, 2-aminoethyl, ethenyl, ethinyl, n-propyl, iso-propyl, propen-3-yl, propin-3-yl, 2-hydroxypropyl, 2-mercaptopropyl, 2-aminopropyl, 3-hydroxypropyl, 3-mercaptopropyl, 3-aminopropyl, n-butyl, 1-buten-4-yl, 1-butin-4-yl, 2-buten-4-yl, 2-butin-4-yl, 2-butyl, iso-butyl, tert-butyl, 2-hydroxybutyl, 2-mercaptobutyl, 2-aminobutyl, 3-hydroxybutyl, 3-mercaptobutyl, 3-aminobutyl, 4-hydroxybutyl, 4-mercaptobutyl, 4-aminobutyl, n-pentyl, iso-pentyl, neo-pentyl, tert-pentyl, hexyl, n-heptyl, iso-heptyl, n-octyl, iso-octyl, 2-ethyl-1-hexyl, 2,2,4-trimethylpentyl, nonyl, decyl, dodecyl, n-dodecyl, cyclopentyl, cyclohexyl, cycloheptyl, methylcyclohexyl, vinyl, 1-propenyl, 2-propenyl, naphthyl, anthranyl, phenanthryl, o-tolyl, p-tolyl, m-tolyl, xylyl, ethylphenyl, mesityl, phenyl, benzyl, trimethylsilyl, triisopropylsilyl, tri(tertbutyl)silyl), dimethylthexylsilyl, trimethylsilylethinyl, dimethyltertbutylsilylethinyl, dimethylthexylsilylethinyl, triisopropylsilylethinyl, tritertbutylsilylethinyl, where amino denotes NR³R⁴.

29. A borate salt according to claim 26, wherein G¹ and G² are independently selected from H, OH, SH, NH₂, N(methyl)₂, O-methyl, S-methyl, methyl, hydroxymethyl, mercaptomethyl, aminomethyl, ethyl, 2-hydroxyethyl, 2-mercaptoethyl, 2-aminoethyl, ethenyl, ethinyl, n-propyl, iso-propyl, propen-3-yl, propin-3-yl, 2-hydroxypropyl, 2-mercaptopropyl, 2-aminopropyl, 3-hydroxypropyl, 3-mercaptopropyl, 3-aminopropyl, n-butyl, 1-buten-4-yl, 1-butin-4-yl, 2-buten-4-yl, 2-butin-4-yl, 2-butyl, iso-butyl, tert-butyl, 2-hydroxybutyl, 2-mercaptobutyl, 2-aminobutyl, 3-hydroxybutyl, 3-mercaptobutyl, 3-aminobutyl, 4-hydroxybutyl, 4-mercaptobutyl, 4-aminobutyl, n-pentyl, iso-pentyl, neo-pentyl, tert-pentyl, hexyl, n-heptyl, iso-heptyl, n-octyl, iso-octyl, 2-ethyl-1-hexyl, 2,2,4-trimethylpentyl, nonyl, decyl, dodecyl, n-dodecyl, cyclopentyl, cyclohexyl, cycloheptyl, methylcyclohexyl, vinyl, 1-propenyl, 2-propenyl, naphthyl, anthranyl, phenanthryl, o-tolyl, p-tolyl, m-tolyl, xylyl, ethylphenyl, mesityl, phenyl, 4-hydroxyphenyl, styryl, pentafluorophenyl, benzyl, trimethylsilyl, triisopropylsilyl, tri(tertbutyl)silyl), dimethylthexylsilyl, trimethylsilylethinyl, dimethyltertbutylsilylethinyl, dimethylthexylsilylethinyl, triisopropylsilylethinyl, tritertbutylsilylethinyl, fluorine, chlorine, bromine, iodine, where amino denotes NR³R⁴.

30. A borate salt according to claim 26, wherein Z-Z′ and Z″-Z′″ independently of one another are selected from:

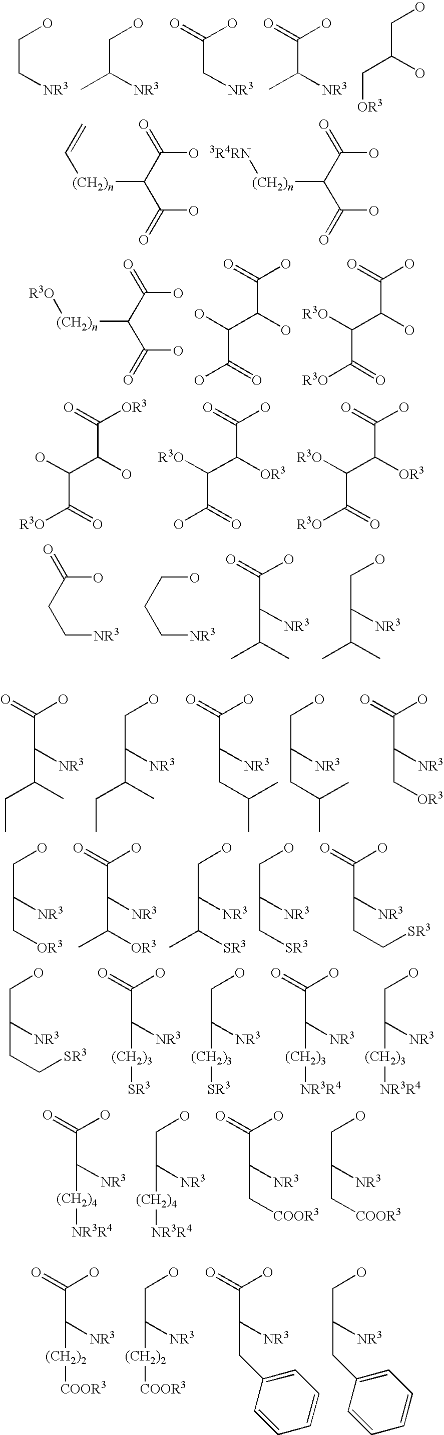

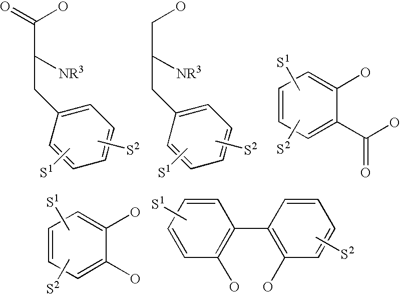

31. A borate salt according to claim 26 that includes the following compounds: hydrogen-(malonato, oxalato)borate (HMOB), hydrogen-bis(malonato)borate (HBMB), hydrogen-(glycolato, oxalato)borate (HGOB), hydrogen-bis(glycolato)borate (HBGB), hydrogen-(lactato, oxalato)borate (HLOB), hydrogen-bis(lactato)borate (HBLB), hydrogen-(oxalato, salicylato)borate (HOSB), hydrogen-bis(salicylato)borate (HBSB), hydrogen(oxalato, tartrato)borate (HOTB), hydrogen(polytartrato)borate (HPTB), hydrogen(oxalato, catecholato)borate (HOCB), hydrogenbis(catecholato)borate (HBCB) as well as their ammonium, alkali metal, alkaline-earth metal, rare-earth metal and main-group metal and transition group metal salts.

32. A borate salt according to claim 26 that is a derivative of both boric acid and tartaric acid.

33. A borate salt according to claim 26, wherein the salt includes the following compounds: lithium poly(tartrato)borate, sodium poly(tartrato)borate, potassium poly(tartrato)borate, aluminum poly(tartrato)borate and calcium poly(tartrato)borate.

34. A borate salt according to claim 26, wherein they include the following compounds: lithium dimalonatoborate, calcium bis(dimalonatoborate), aluminum tris(dimalonatoborate), calcium bis(disalicylatoborate).

35. A borate salt according to claim 26, wherein M^{y+} is a lithium, sodium, potassium, caesium, calcium, zinc, neodymium, lanthanum, aluminum, tetraalkylammonium, tetramethylammonium, tetraethylammonium, tetrapropylammonium, tetrabutylammonium, dimethylanilinium ion or is a mixture of trialkylammonium ions of amines that contain mixtures of two C₁₄, C₁₆ or C₁₈ alkyl groups and a methyl group.

36. A process comprising preparing a borate salt according to claim 26 by reacting at least one of boric acid or one or more boric acid esters with a protonated compound HZ-Z′H or HZ″-Z′″H and a carbonate [(M^{y+})₂(CO₃)_{y}] of the cation M^{y+} or a hydroxide [(M^{y+})(OH)_{y}] of the cation M^{y+} or an oxide [(M^{y+})₂(O)_{y}] of the cation M^{y+} or an alcoholate [(M^{y+})(OR³)_{y}] of the cation M^{y+} or an alkyl [(M^{y+})(R³)_{y}] of the cation M^{y+} or a compound NR³R⁴R⁵ or a compound [(NR³R⁴R⁵R⁶)⁺Q⁻] or a mixture of at least two of the carbonates and/or hydroxides and/or oxides and/or alcoholates and/or alkyls and/or a compound [(NR³R⁴R⁵R⁶)⁺Q⁻] and/or a compound NR³R⁴R⁵ in a suitable solvent, where Q⁻ is an anion, preferably a halide, particularly preferably chloride, or a sulfate or hydrogen sulfate.

37. A process according to claim 36, wherein water is added to the reaction mixture.

38. A process according to claim 36, wherein the water of reaction or the alcohol of reaction that is formed is removed, preferably by azeotropic distillation.

39. A process according to claim 36, wherein after the reaction the solvent is completely removed in vacuo.

40. A process according to claim 36, wherein the solvent is selected from: benzene, toluene, ethylbenzene, m-xylene, p-xylene, o-xylene, cumene, other derivatised benzenes, hexane, heptane, cyclohexane, methylcyclohexane, other hydrocarbon mixtures such as shellsol or halpasol, chloroform, carbon tetrachloride, ethyl acetate, acetone, ethylene carbonate, acetonitrile, or mixtures of at least two of these solvents.

41. A process according to claim 36, wherein the ratio of the equivalent of boric acid or boric acid ester to the equivalent of the protonated compounds HZ-Z′H or HZ″-Z′″H is 1:0.5 to 3, particularly preferably 1:1 to 2.5, and the ratio of the equivalent of boric acid or boric acid ester to the equivalent of the cation M^{y+} is (y±1) to 1, particularly preferably (y±0.1) to 1.

42. A process comprising admixing a polymer with a borate salt according to claim 26 to form a borate-containing polymer.

43. The method according to claim 42, wherein the a borate salt in polymer is added in an amount sufficient to act as a stabilizer against at least one of thermal or photochemical decomposition.

44. The method according to claim 42, wherein the borate salt is present in an amount sufficient to act as at least one of a flameproofing agent or conductivity improvers.

45. The method of claim 42, wherein the polymer is selected from: polylactate, polyesters, preferably polyethylene terephthalate (PET), polybutylene terephthalate (PBT), polyethyelene naphthenate (PEN), polyamides, preferably nylon, Nomex, Kevlar, halogen-containing polymers, preferably PVC, polytetrafluoroethene (PTFE), polyolefins, preferably polyethylene (PE), polypropylene (PP), polystyrenes, polyacrylates and polyurethanes.

46. The method of claim 36, wherein the polymer is selected from thermoplastic elastomers, preferably from butadiene rubber (BR), polyisoprene, butadiene/styrene polymers or natural rubbers or natural latex or synthetic latex or mixtures or at least two of these elastomers.

47. The method according to claim 36, wherein the a borate salt are added to the polymer in an amount of 0.0001 to 10 wt. %.

48. The method according to claim 36, wherein the polymer containing the borate salts if formed into a bottle, a film, a sheet, a fiber, a molded article, a shoe sole, a foamed article, a material with a glass-like appearance, an automobile tire, a rubber, a lacquer, a powdered lacquer, a piping, a drinking water pipe, a waste water pipe, a profiled section, a window profile, foodstuff packaging, a computer keyboard, a computer housing, a screen housing, an electronic component, blister packaging or an industrial plastic.

49. An article of manufacture comprising a borate salt according to claim 26.

50. A composition comprising a polymer and a borate salt according to claim 26.
